(19) United States
(12) Patent Application Publication
(10) Pub. No.: US 2017/0278244 A1
(43) Pub. Date: Sep. 28, 2017

(54) METHOD AND A SYSTEM FOR NON-RIGID IMAGE REGISTRATION

(71) Applicant: THE CHINESE UNIVERSITY OF HONG KONG, Hong Kong (CN)

(72) Inventors: Yishan Luo, Hong Kong (CN); Lin Shi, Hong Kong (CN); Defeng Wang, Hong Kong (CN)

(21) Appl. No.: 15/080,336

(22) Filed: Mar. 24, 2016

(51) Int. Cl. G06T 7/00

(52) U.S. Cl. CPC G06T 7/0036; G06T 2207/20221

(57) ABSTRACT

Disclosed is a method for non-rigid image registration, comprising: dividing a subject image and a target image into a plurality of subject sub-images and a plurality of target sub-images, respectively; registering, in parallel, each of the subject sub-images and the corresponding one of the target sub-images to obtain a transformation matrix of the each of the subject sub-images relative to the corresponding one of the target sub-images; transforming, based on by the obtained transformation matrices, the subject sub-images into images corresponding to the target sub-images; and merging the transformed images to form a final registered image having the resolution of the target image. A system and a device for non-rigid image registration are also enclosed within the disclosure.

### TECHNICAL FIELD

The disclosures relate to a method and a system for non-rigid image registration.

### BACKGROUND

Image registration, as a procedure of establishing spatial relationship between images, has played an important role in medical image processing, group analysis and many other clinical applications. Many medical image analysis methods, such as structure segmentation, population-based studies, volumetric and morphologic measurements, employ the registration-based scheme to achieve high performance. Through decades of effort, this research field has witnessed great advances improving image registration accuracy by using various approaches. However, in recent years, with an ever increasing amount of acquired medical images and a continuously increased image resolution, the computational cost of a registration algorithm has become a critical problem and the bottleneck which limits the application of image registration to many clinical practices which require quick responses.

In particular, computation time is a big constraint for 3D non-rigid neuroimage registration in clinical practices. Non-rigid image registration, due to the complexity of optimization on the high degree-of-freedom transformation, is an extremely time-consuming procedure, especially when the current neuroimage sizes have increased tremendously with the advent of advanced scanners. The non-rigid registration has many parameters (frequently up to a 10⁶ dimensional space) to be optimized, leading to a typical runtime of a registration algorithm in an order of 10 minutes, up to hours.

In the recent decades, there were increasing efforts dedicated to improve the image registration efficiency. In general, the acceleration of registration algorithms can be addressed on two fronts. One is to design a new registration algorithm with improved computational efficiency in mind; and the other is to make the best use of the computational power of the hardware to speed up the registration process.

As for algorithm-oriented registration efficiency improvement, one idea to speed up the non-rigid registration is rather than to use all the information in the whole image domain, instead the particular attention has been paid to a subset of important regions. A hybrid method was proposed to utilize sparse salient region feature correspondences to estimate both the global rigid transformation and the local deformation field with a local free-form deformation model in a closed form. A strategy of using a priori knowledge to increase the confidence of certain regions is also investigated, which can reduce the dimensionality of the registration problem.

In addition, some prior knowledge of the deformation field can be used to speed up the registration process. However, the registration accuracy of those newly developed efficient registration algorithms cannot yet compete with the conventional top-performing registration methods, e.g., ANTs, ART, IRTK. As for hardware-based registration efficiency improvement, the acceleration of image registration algorithms was usually achieved by exploiting parallelism, and the high-performance computing systems, such as computer clusters, shared-memory multi-processors and GPUs, have all been exploited for this purpose. However, parallelism is not applicable for all the registration methods. One essential requirement for the parallelizable algorithm is that it should be easy to be divided into a number of parallel portions, so that each portion can be assigned to one individual device. Some inherently serial algorithms cannot be split up into parallel portions, as they require the results from a preceding step to effectively carry on with the next step.

Therefore, it is desired to propose a general registration acceleration framework for speeding up the existing non-rigid registration methods without any modification of the original registration methods.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope of particular embodiments of the disclosure, or any scope of the claims. Its sole purpose is to present some concepts of the disclosure in a simplified form as a prelude to the more detailed description that is presented later.

In an aspect, disclosed is a method for non-rigid image registration, comprising: dividing a subject image and a target image into a plurality of subject sub-images and a plurality of target sub-images, respectively; registering, in parallel, each of the subject sub-images and corresponding one of the target sub-images to obtain a transformation matrix of the each of the subject sub-images relative to the corresponding one of the target sub-images; transforming, based on the obtained transformation matrix, the subject sub-images into images corresponding to the target sub-images; and merging the transformed images to form a final registered image having a resolution of the target image.

In one embodiment of the present application, the dividing is implemented by interleaving down-sampling.

In one embodiment of the present application, the subject image and the target image are divided such that each of the subject sub-images corresponds to one of the target sub-images.

In one embodiment of the present application, the dividing further comprises: dividing the subject image and the target image into a plurality of first lower-resolution images and a plurality of second low-resolution images, respectively.

In one embodiment of the present application, the merging comprises: interpolating, the transformed images to obtain converted images having the resolution of the target image; and averaging the obtained images to form the final registered image having the resolution of the target image.

In one embodiment of the present application, the method further comprises: acquiring, by an image acquisition system/device, a subject image and a target image from patients, the subject image and the target image being obtained independently. In one embodiment of the present application, the image acquisition system/device comprises a first system and a second system to obtain the subject image and the target image independently. In one embodiment of the present application, the image acquisition system is configured to obtain the subject image and the target image from a same patient at different time. In one embodiment of the present application, the image acquisition system is configured to acquire the subject image and the target image from different patients.

In an aspect, disclosed is a system for non-rigid image registration, comprising: a down-sampler for dividing a subject image and a target image into a plurality of subject sub-images and a plurality of target sub-images, respectively; a registration unit for registering, in parallel, each of the subject sub-images and corresponding one of the target sub-images to obtain a transformation matrix of the each of the subject sub-images relative to the corresponding one of the target sub-images; a transformer for transforming, based on by the obtained transformation matrix, the subject sub-images into images corresponding to the target sub-images; and a merger for merging the transformed images to form a final registered image having a resolution of the target image.

In an aspect, disclosed is a system for non-rigid image registration, comprising: an image acquisition system/device configured to obtain a subject image and a target image from patients, wherein the subject image and the target image are obtained independently; a controller retrieving the obtained subject image and the target image and comprising: a down-sampler for dividing a subject image and a target image into a plurality of subject sub-images and a plurality of target sub-images, respectively; a registration unit for registering, in parallel, each of the subject sub-images and corresponding one of the target sub-images to obtain a transformation matrix of the each of the subject sub-images relative to the corresponding one of the target sub-images; a transformer for transforming, based on by the obtained transformation matrices, the subject sub-images into images corresponding to the target sub-images; and a merger for merging the transformed images to form a final registered image having a resolution of the target image. The system may further comprises a displayer electronically communicated with the controller and displaying the final registered image received from the merger, thereby causing at least one of monitoring of tumor growth and determination of treatment position based on the displayed final registered image.

### BRIEF DESCRIPTION OF THE DRAWING

Exemplary non-limiting embodiments of the present application are described below with reference to the attached drawings. The drawings are illustrative and generally not to an exact scale. The same or similar elements on different figures are referenced with the same reference numbers.

FIG. 1 illustrates the difference between the registration method of the present disclosure and the traditional registration method.

FIG. 2 illustrates a system for non-rigid image registration according to an embodiment of the present application.

FIG. 3 is a flowchart illustrating a method for non-rigid image registration according to an embodiment of the present application.

FIG. 4 shows an example of dividing a 2D image into a plurality of lower-resolution images according to an embodiment of the present application.

FIG. 5 shows an example of dividing the subject image and the target image into a plurality of subject and target lower-resolution images, respectively, according to an embodiment of the present application.

FIG. 6 shows an example of transforming the subject lower-resolution image into a transformed subject lower-resolution image according to an embodiment of the present application.

FIG. 7 shows an example of converting the transformed subject lower-resolution image into a converted image according to an embodiment of the present application.

### DETAILED DESCRIPTION

Reference will now be made in detail to some specific embodiments of the invention including the best modes for carrying out the invention. Examples of these specific embodiments are illustrated in the accompanying drawings. While the invention is described in conjunction with these specific embodiments, it will be appreciated by one skilled in the art that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present application. The present application may be practiced without some or all of these specific details. In other instances, well-known process operations have not been described in detail in order not to unnecessarily obscure the present application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

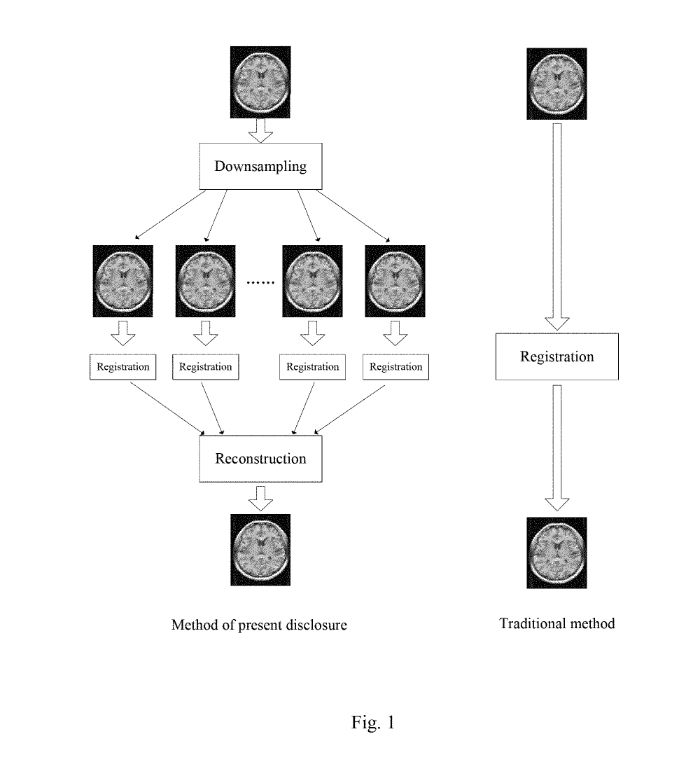

In practical application, in order to match a subject image and a target image, a non-rigid image registration usually needs to be applied between the subject image and the target image to convert the subject in to a coordinate system of the target image, after an affine registration. The runtime of one pair of non-rigid image registration is closely related to the resolution of the images. In general, the registration between the higher-resolution images involves more transformation parameters to be estimated, which consequently increases the computational cost. Based on this principle, the present disclosure discloses a method for non-rigid image registration. The difference between the present method and the traditional registration method is illustrated in FIG. 1. As shown in FIG. 1, the traditional registration method implements image registration in a serial manner, time taken by the traditional registration method will increase with the increasing of the resolution of the images. In the method of the present disclosure, the images for registration are firstly divided into several lower-resolution images with lower resolution through down-sampling, then the registrations are performed between the corresponding lower-resolution image pairs in parallel, and finally the images after registration are merged into the final registered image. Due to the lowered image resolution, the computation time of the registration between down-sampled image pairs is reduced. Meanwhile, the registrations of the down-sampled image pairs may be executed simultaneously. The whole registration process is thus accelerated in this manner.

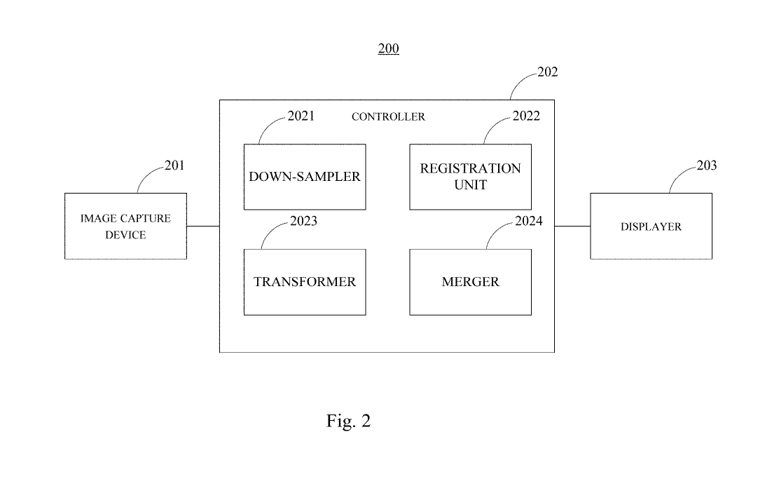

FIG. 2 illustrates a system 200 for non-rigid image registration according to an embodiment of the present application. As shown in FIG. 2, the system 200 may comprise an image acquisition device 201, a controller 202, and a displayer 203 communicated with the controller. The image acquisition device 201 may comprise a Magnetic Resonance Imaging (MRI) device, a CT scanner and the like. The controller 202 may comprise a down-sampler 2021, a registration unit 2022, a transformer 2023 and a merger 2024, which will be discussed hereinafter.

The image acquisition device 201 operates to obtain a subject image and a target image, for example, from patients, wherein the subject image and the target image are obtained independently. According to one embodiment, the image acquisition device 201 comprises a first acquirer and a second acquirer (not shown) to obtain the subject image and the target image independently. For example, the subject image may be obtained by the CT scanner, and the target image may be obtained by the MRI device. In some medical applications, the subject image and the target image may be obtained from a same patient at different times, to observe disease progress, such as tumor growth, or to determine treatment position by matching the subject image obtained before operation and the target image obtained during operation. According to another embodiment, the image acquisition device 201 is configured to acquire the subject image and the target image from different patients. For example, in some medical applications, the subject image may be obtained from a patient under diagnosing, and the target image may be obtained from a patient whose disease has been determined, then the registration between the subject image and the target image may assist to determine the disease of the patient under diagnosing.

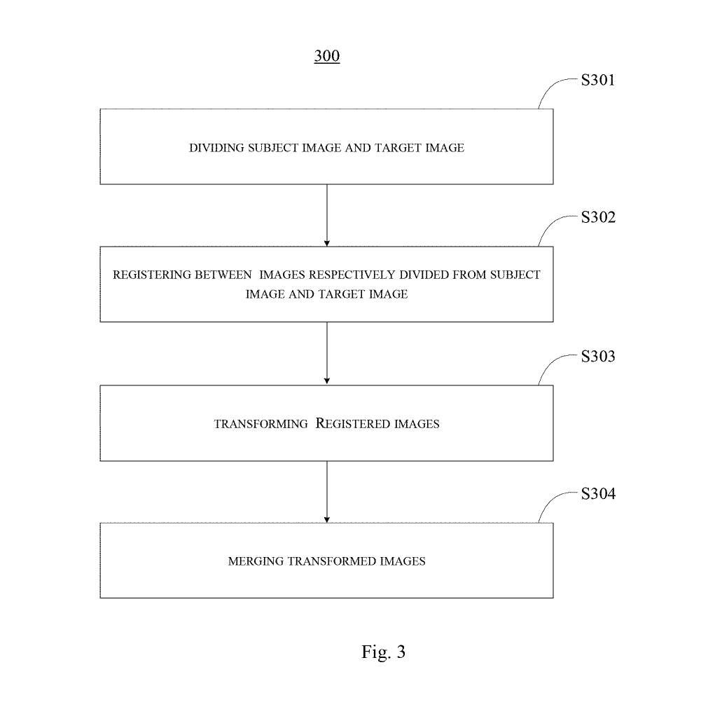

The controller 20 operates to retrieve the obtained subject image and the target image, for example, directly from the image acquisition device 201, and the retrieved images are then processed by the down-sampler 2021, the registration unit 2022, the transformer 2023 and the merger 2024, which will be further discussed in reference to FIGS. 3-7.

FIG. 3 is a flowchart illustrating a method for non-rigid image registration. At step S301, the down-sampler 2021 divides a subject image and a target image into a plurality of subject sub-images and a plurality of target sub-images, respectively. For example, the down-sampler 2021 operates to perform the down-sampling process to divide the subject image and the target image into a plurality of subject sub-images and a plurality of target sub-images. In one embodiment of present application, the down-sampler 2021 may be implemented with or integrated circuits (ICs), such as a digital signal processor and software therefore or application specific ICs. In another embodiment of the present application, the down-sampler 2021 may be implemented with computer-implemented software.

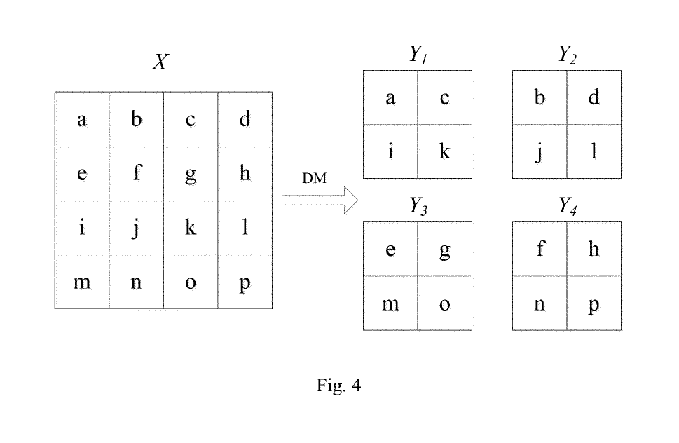

FIG. 4 illustrates an example of dividing an image into a plurality of sub-images, wherein the image X may be the subject image and the target image described above. In the embodiment of FIG. 4, the subject sub-image and the target sub-image may be a first lower-resolution image and a second lower-resolution image respectively, wherein the first lower-resolution image has lower resolution than the subject image and the second lower-resolution image has lower resolution than the target image. As shown in FIG. 4, the image X is composed of a plurality of pixels. It should be noted, while the resolution of the image X is 4×4 as shown in FIG. 4, the resolutions of subject image and a target image may be other resolution according to actual conditions and the resolutions of the subject image and the target image may be different. The image X may be divided into N lower-resolution images Yₖ through the following operation:

Yₖ=DₖMₖX k=1, . . . , N (1)

where Dₖ is the decimation operator and Mₖ is the geometric motion operator, wherein operator D indicates the motion of a sampling region and the operator M indicates the density of the sampling. As shown in FIG. 4, the image X is separated into several lower-resolution images Yₖ by interleaving down-sampling. The operation is a lossless process that doesn't change or lose any pixel value.

Specifically, as shown in FIG. 4, the image X is composed of pixels a-p, and the image X may be down-sampled by interleaving down-sampling. In the example of FIG. 4, the image X is divided into four lower-resolution images Y₁-Y₄. In present embodiment, the sampling region is composed of a plurality of pixels, for example 16 pixels such as pixels a-p as shown. When sampling lower-resolution image Y₁, the sampling region is composed of pixels a-p, and the sampling is performed by selecting one pixel every two pixels, that is, the sampling density is one pixel every two pixels. Finally, the sampled lower-resolution image Y₁ is composed of pixels a, c, i, k as shown in FIG. 4. Then, when sampling the lower-resolution image Y₂, the sampling region moves to the right by one pixel relative to the sampling region of the lower-resolution image Y₁, that is, the sampling region of the lower-resolution image Y₂ is composed of pixels b, c, d, f g, h, j, k, l, n, o, p and four pixels (not shown in FIG. 4) on the right side of pixels d, h, l, p, wherein the 4 more pixels at the right boundary are omitted, or 0 can be padded to compensate the 4 pixels, due to the boundary effect. The sampling density is also one pixel every two pixels, and the sampled lower-resolution image Y₂ is composed of pixels b, d, j, l. In the similar manner, the lower-resolution images Y₃ and Y₄ are obtained, wherein the sampling region of the lower-resolution images Y₃ moves down one pixel relative to the sampling region of the lower-resolution images Y₁, and the sampling region of the lower-resolution images Y₄ moves down one pixel relative to the sampling region of the lower-resolution images Y₂. It should be noted that, while the embodiment is described using an example of 2D image, the method also may be used for 3D image. In the case of 3D image, the sampling region may be a cube region, such as a cube region with 4×4×4 pixels.

The subject image and the target image may be divided into a plurality of first lower-resolution images and a plurality of second lower-resolution images by the above method, respectively, wherein the term “first lower-resolution image” only indicates the lower-resolution image divided from the subject image and the term “second lower-resolution image” only indicates the lower-resolution image divided from the target image. The first lower-resolution images may be different from each other, and the second lower-resolution images may be different from each other.

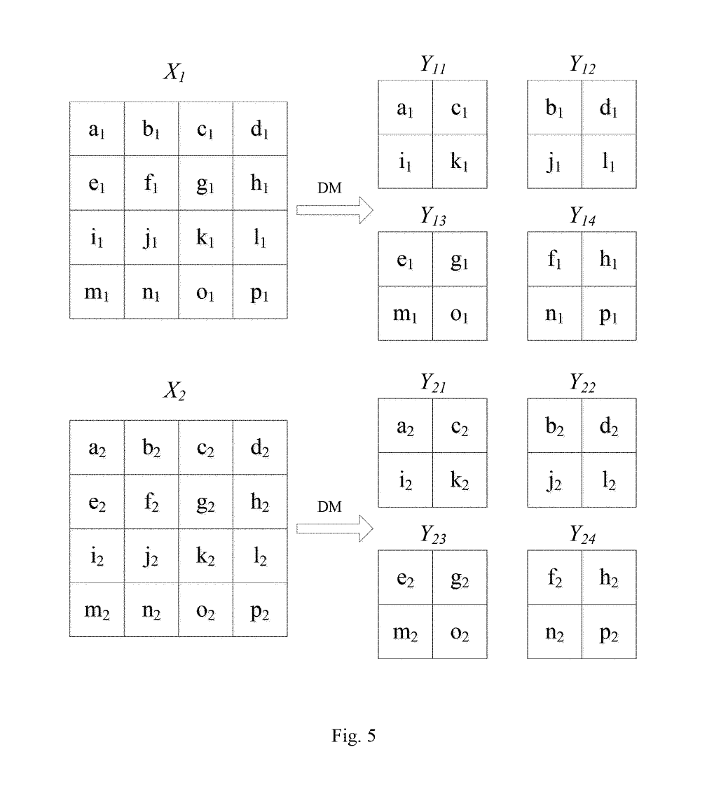

FIG. 5 shows an example of dividing of the subject image X₁ and the target image X₂. As shown in FIG. 5, the subject image X₁ and the target image X₂ are divided by above described interleaving down-sampling. In the present embodiment, the dividing manners of the subject image and the target image may be same, the subject image and the target image may be divided into lower resolution images with same number and same constitution manner. Specifically, the subject image and the target image are divided into the first lower-resolution images Y₁₁, Y₁₂, Y₁₃, Y₁₄, and the second lower-resolution images Y₂₁, Y₂₂, Y₂₃, Y₂₄, respectively, and the first lower-resolution images and the second lower-resolution images are one-to-one corresponding, i.e., the first lower-resolution image Y₁₁ is corresponding to the second lower-resolution image Y₂₁, the first lower-resolution image Y₁₂ is corresponding to the second lower-resolution image Y₂₂, the first lower-resolution image Y₁₃ is corresponding to the second lower-resolution image Y₂₃, and the first lower-resolution image Y₁₄ is corresponding to the second lower-resolution image Y₂₄.

In some embodiment, selections of the sampling region and the sampling density of the subject image and the target image may be different, and the numbers of the first and second lower-resolution images are same.

Now return to FIG. 3, after dividing the subject image and the target image, at step S302, the divided image is inputted into the registration unit 2022, and the registration unit 2022 in turn operates to the registration process, i.e., to register, in parallel, each of the first lower-resolution images and the corresponding one of the second lower-resolution images. For example, the registration may be performed between the first lower-resolution image Y₁₁ and the second lower-resolution image Y₂₁, the first lower-resolution image Y₁₂ and the second lower-resolution image Y₂₂, the first lower-resolution image Y₁₃ and the second lower-resolution image Y₂₃, the first lower-resolution image Y₁₄ and the second lower-resolution image Y₂₄ as shown in FIG. 5. The method of the registration may the any non-rigid registration method, such as, the Symmetric image normalization (SyN), automatic registration tool (ART) and the image registration toolkit (IRTK).

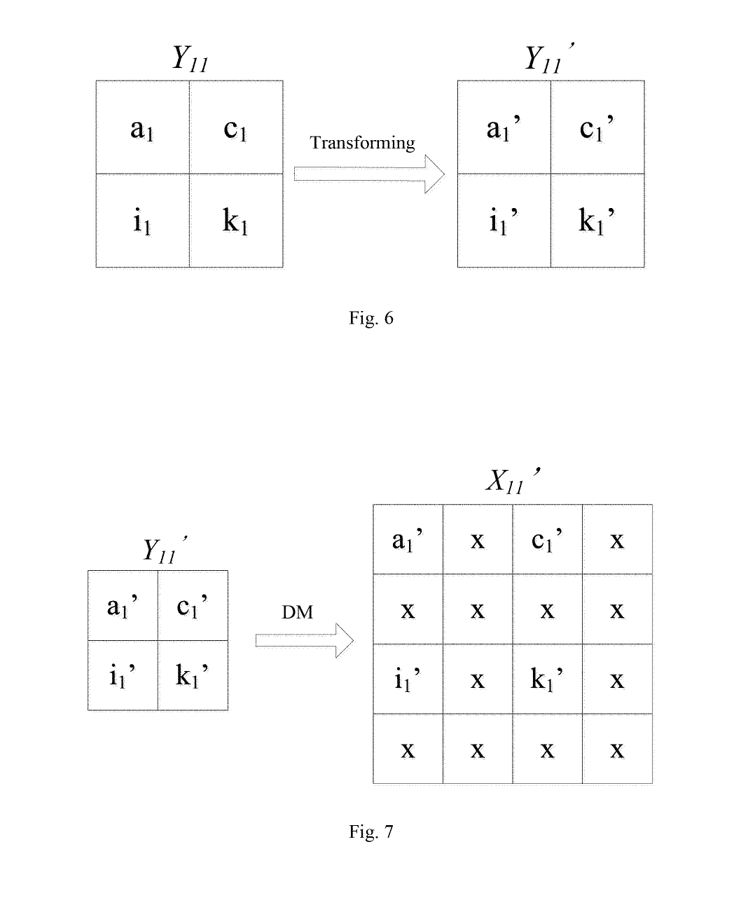

After registration, a transformation matrix of the each of the first lower-resolution images relative to the corresponding one of the second lower-resolution images can be obtained. Then, at step S303, the transformation matrix is inputted into the transformer 2023, and the transformer 2023 transforms each of first lower-resolution images by the transformation matrix. For example, as shown in FIG. 6, the first lower-resolution image Y₁₁ is transformed into a transformed first lower-resolution image Y₁₁′ by the transformation matrix of the first lower-resolution image Y₁₁ relative to the second lower-resolution images Y₂₁. The other first lower-resolution images Y₁₂, Y₁₃, Y₁₄, may be transformed into transformed first lower-resolution images Y₁₂′, Y₁₃′, Y₁₄′ analogously.

After obtaining transformed first lower-resolution images, at step S304, the transformed first lower-resolution images are inputted into the merger 2024, and the merger 2024 then merges the transformed first lower-resolution images to form a final registered image having the resolution of the target image. In some embodiment, as shown in FIG. 7, the transformed first lower-resolution image may be firstly converted into a converted image having the resolution of the target image by interpolating, wherein interpolating can be implemented by the method known by the skilled in the art, such as bilinear interpolation, cubic B-spine interpolation and the like. As shown in FIG. 7, data of the pixel a₁′ in the transformed first lower-resolution image Y₁₁′ is filled in the position in the converted image that corresponding to the position where pixel a₁ located relative to the subject image X₁ as shown in FIG. 7. In this manner, data of the pixels c₁′, i₁′, k₁′, is filled in the corresponding positions respectively. data of pixels in other potions x in the converted image may be obtained by interpolating according to pixels a₁′, c₁′, i₁′, k₁′. This operation is equivalent to the reverse operation of operator D and operator M

While the other pixels are all indicated by x in FIG. 7, it should be understood that this is only for the convenience of description, and data of these pixels may be different from each other. In the embodiment of FIG. 5, the converted images Y₁₂′, Y₁₃′, Y₁₄′ may be obtained in the similar way as the converted image Y₁₁′. Then, the obtained converted images are averaged to form the final registered image having the resolution of the target image. In some embodiment, the averaging may be implemented by adding all converted images together and dividing the added result by the number of the converted images.

The step S304 may be described by Eq. 2:

$$\tilde{X} ( h ) = \frac{1}{N} {\sum }_{k = 1}^{N} {D}_{k}^{T} {M}_{k}^{T} {Y}_{k} ( {h}_{k} ) \qquad ( 2 )$$

where Dₖ^{T} and Mₖ^{T} are the inverse operation of decimation and motion compensation. hₖ is the transformation field, such as transformation matrix estimated by kth pair of lower-resolution images. \tilde{X}(h) is the final registered image. The solutions of each pair of lower-resolution registration (Dₖ^{T}Mₖ^{T}Yₖ(hₖ)) are then fused in an average manner to form the final solution. In this way, the registration errors of each lower-resolution image pair can be averaged out.

The displayer 203 is electronically communicated with the controller and may display the final registered image received from the merger 2024, in some embodiment, the doctor can perform the monitoring of tumor growth and the determination of treatment position based on the displayed final registered image.

As will be appreciated by one skilled in the art, the present application may be embodied as a system, a method or a computer program product. Accordingly, the present application may take the form of an entirely hardware embodiment and hardware aspects that may all generally be referred to herein as a “unit”, “circuit,” “module” or “system.” Much of the inventive functionality and many of the inventive principles when implemented, are best supported with or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating ICs with minimal experimentation. Therefore, in the interest of brevity and minimization of any risk of obscuring the principles and concepts according to the present application, further discussion of such software and ICs, if any, will be limited to the essentials with respect to the principles and concepts used by the preferred embodiments.

Although the preferred examples of the present application have been described, those skilled in the art can make variations or modifications to these examples upon knowing the basic inventive concept. The appended claims are intended to be considered as comprising the preferred examples and all the variations or modifications fell into the scope of the present application.

Obviously, those skilled in the art can make variations or modifications to the present application without departing the spirit and scope of the present application. As such, if these variations or modifications belong to the scope of the claims and equivalent technique, they may also fall into the scope of the present application.

1. A method for non-rigid image registration, comprising:
acquiring, by an image acquisition device, a subject image and a target image from patients, the subject image and the target image being obtained independently;
obtaining, by a controller, the acquired images from the image acquisition device;
dividing, in the controller, the subject image and the target image into a plurality of subject sub-images and a plurality of target sub-images, respectively;
registering, in parallel, each of the subject sub-images and corresponding one of the target sub-images to obtain a transformation matrix of the each of the subject sub-images relative to the corresponding one of the target sub-images;
transforming, based on the obtained transformation matrices, the subject sub-images into images corresponding to the target sub-images; and
merging the transformed images to form a final registered image having a resolution of the target image,
wherein the dividing is implemented by an interleaving down-sampling process which does not change or lose any pixel value in the subject image and the target image.

2. (canceled)

3. The method of claim 1, wherein the subject image and the target image are divided such that the each of the subject sub-images corresponds to the one of the target sub-images.

4. The method of claim 1, wherein the dividing further comprises:
dividing the subject image and the target image into a plurality of first lower-resolution images and a plurality of second low-resolution images, respectively.

5. The method of claim 4, wherein the merging comprises:
interpolating, the transformed images to obtain converted images having the resolution of the target image; and
averaging the obtained images to form the final registered image having the resolution of the target image.

6. The method of claim 1, wherein the image acquisition device comprises a first acquirer and a second acquirer, and the subject image and the target image are respectively acquired by the first and the second acquirer independently.

7. The method of claim 1, wherein the image acquisition device is configured to acquire the subject image and the target image from a same patient at different times.

8. The method of claim 1, wherein the image acquisition device is configured to acquire the subject image and the target image from different patients.

9. The method of claim 1, further comprising:
displaying the final registered image, thereby causing at least one of monitoring of tumor growth and determination of treatment position based on the displayed final registered image.

10. A system for non-rigid image registration, comprising:
an image acquisition device capturing a subject image and a target image from patients, the subject image and the target image being obtained independently;
a controller retrieving the subject image and the target image and comprising:
a down-sampler dividing the subject image and the target image into a plurality of subject sub-images and a plurality of target sub-images, respectively;
a registration unit registering, in parallel, each of the subject sub-images and corresponding one of the target sub-images to obtain a transformation matrix of the each of the subject sub-images relative to the corresponding one of the target sub-images;
a transformer transforming, based on by the obtained transformation matrices, the subject sub-images into images corresponding to the target sub-images; and
a merger merging the transformed images to form a final registered image having a resolution of the target image; and
a displayer electronically communicated with the controller and displaying the final registered image received from the merger, thereby causing at least one of monitoring of tumor growth and determination of treatment position based on the displayed final registered image,
wherein the down-sampler is configured to implement the division by an interleaving down-sampling process which does not change or lose any pixel value in the subject image and the target image.

11. The system of claim 10, wherein the image acquisition device comprises a first acquirer and a second acquirer to obtain the subject image and the target image independently.

12. The system of claim 10, wherein the image acquisition device is configured to acquire the subject image and the target image from a same patient at different times.

13. The system of claim 10, wherein the image acquisition device is configured to acquire the subject image and the target image from different patients.

14. (canceled)

15. The system of claim 14, wherein the down-sampler is further configured to divide the subject image and the target image such that the each of the subject sub-images corresponds to the one of the target sub-images.

16. The system of claim 15, wherein the down-sampler is further configured to divide the subject image and the target image into a plurality of subject lower-resolution images and a plurality of target low-resolution images, respectively.

17. The system of claim 10, wherein the merger is further configured to:
interpolate, the transformed images to obtain converted images having the resolution of the target image; and
average the obtained images to form the final registered image having the resolution of the target image.

18. A device for non-rigid image registration, comprising:
a down-sampler for dividing a subject image and a target image into a plurality of subject sub-images and a plurality of target sub-images, respectively;
a registration unit for registering, in parallel, each of the subject sub-images and corresponding one of the target sub-images to obtain a transformation matrix of the each of the subject sub-images relative to the corresponding one of the target sub-images;
a transformer for transforming, based on the obtained transformation matrices, the subject sub-images into images corresponding to the target sub-images; and
a merger for merging the transformed images to form a final registered image having a resolution of the target image,
wherein the down-sampler is further configured to implement the dividing by an interleaving down-sampling process which does not change or lose any pixel value in the subject image and the target image.

19. (canceled)

20. The device of claim 18, wherein the down-sampler is further configured to divide the subject image and the target image such that the each of the subject sub-images corresponds to the one of the target sub-images.

21. The device of claim 18, wherein the down-sampler is further configured to divide the subject image and the target image into a plurality of subject lower-resolution images and a plurality of target low-resolution images, respectively.

22. The device of claim 21, wherein the merger is further configured to:
interpolate, the transformed images to obtain converted images having the resolution of the target image; and
average the obtained images to form the final registered image having the resolution of the target image.
